(19) United States
(12) Patent Application Publication
(10) Pub. No.: US 2020/0071165 A1
(43) Pub. Date: Mar. 5, 2020

(54) PREPARATION OF HIGH-PURITY CHLORINE DIOXIDE

(71) Applicant: GuangXi University, Nanning (CN)

(72) Inventors: Shuangfei WANG, Nanning (CN); Zhan LEI, Nanning (CN); Huang BINGGUI, Nanning (CN); Xu CUISHENG, Nanning (CN); Liu LIANGQING, No.12 Kexing Road (CN); Li ZHONGPING, Nanning (CN); Tan LANG, Nanning (CN)

(73) Assignee: GuangXi University

(21) Appl. No.: 16/268,408

(22) Filed: Feb. 5, 2019

Related U.S. Application Data
(63) Continuation-in-part of application No. 16/310,812, filed on Dec. 17, 2018.

(51) Int. Cl. C01B 11/02

(52) U.S. Cl. CPC C01B 11/026; C01P 2006/80

(57) ABSTRACT

A method for preparing high-purity chlorine dioxide by using methanol and hydrogen peroxide as a reducing agent includes injecting concentrated sulfuric acid and sodium chlorate solution into a generator system to form a reaction mother liquid. The method also includes adding the reducing agent into the reaction mother liquid to produce chlorine dioxide gas and by-product sodium sulfate. The method further includes cooling and absorbing the produced chlorine dioxide gas by 4-10° C. chilled water to obtain a chlorine dioxide aqueous solution. The by-product sodium sulfate is filtered, washed, and recycled.

### CROSS-REFERENCE TO RELATED APPLICATION

This application is a continuation-in-part (CIP) of U.S. Non-Provisional application Ser. No. 16/310,812, filed on Dec. 17, 2018, which claims the benefit of International (PCT) Application No. PCT/CN2018/000307, filed on Aug. 30, 2018. The subject matter thereof is hereby incorporated herein by reference in its entirety.

### FIELD

The present invention relates to producing chlorine dioxide, and more particularly, to a producing high-purity chlorine dioxide by using a methanol and hydrogen peroxide as a reducing agent.

### BACKGROUND

Chlorine dioxide (ClO₂) is an orange-yellow gas at normal temperature and pressure. This gas has a pungent pungency similar to a mixture of chlorine and ozone. The gas boiling point is 11° C., the gas freezing point is −59° C., and the gas density at 3° C. is 3.09 g/M3.

Gaseous chlorine dioxide (ClO₂) is unstable. For example, when gaseous chlorine dioxide (ClO₂) is exposed to light or in contact with organics at high concentrations, the gaseous chlorine dioxide (ClO₂) causes decomposition to produce oxygen and chlorine. In general, chlorine dioxide (ClO₂) is prepared and used on-site. It is stable at normal temperature with air or steam diluted to a volume content below 12 percent or in a low-temperature aqueous solution. Further, the solubility of chlorine dioxide (ClO₂) in water decreases with increasing temperature. Chlorine dioxide (ClO₂) has strong oxidizing capacity and can be used as bleacher for pulp and textiles, water treatment, new air purification freshener and disinfectant for diet, epidemic prevention and sanitation.

Currently, the common method use for industrially preparing chlorine dioxide (ClO₂) is the process associated with sodium chlorate. This method uses methanol, hydrochloric acid, sodium chloride, hydrogen peroxide or sulfur dioxide as reducers. Further, this method uses methanol as a reducing agent.

Although this method may be efficient, the product, chlorine dioxide (ClO₂), contains certain amount of chlorine gas, along with high sulfuric acid consumption high and with needing to neutralize the by-product acid salt cake prior to recycling.

Thus, an alternative preparation process may be beneficial.

### SUMMARY

Certain embodiments of the present invention may provide solutions to the problems and needs in the art that have not yet been fully identified, appreciated, or solved by current processes for preparing chlorine dioxide (ClO₂). For example, some embodiments generally pertain to preparing chlorine dioxide (ClO₂) by the combined reduction of methanol and hydrogen peroxide as a reducing agent to improve the purity of the product, and at the same time, directly crystallizing the by-products in the form of sodium sulfate, thereby reducing consumption of sodium sulfate.

In an embodiment, a method for preparing high-purity chlorine dioxide (ClO₂) by using methanol and hydrogen peroxide as a reducing agent includes injecting concentrated sulfuric acid and sodium chlorate solution into a generator system to form a reaction mother liquid. The method also includes adding the reducing agent into the reaction mother liquid to produce chlorine dioxide (ClO₂) gas and by-product sodium sulfate. The method further includes cooling and absorbing the produced chlorine dioxide (ClO₂) gas by 4-10° C. chilled water to obtain a chlorine dioxide (ClO₂) aqueous solution. The by-product sodium sulfate is filtered, washed, and recycled.

In another embodiment, a method for producing high-purity chlorine dioxide (ClO₂) by using a methanol and hydrogen peroxide as a reducing agent includes injecting concentrated sulfuric acid and sodium chlorate solution into a generator to form a reaction mother liquid. The generator being maintained in a vacuum and pressure being set between −78 to −82 kPa. The method also includes adding the reducing agent into the reaction mother liquid to produce chlorine dioxide (ClO₂) gas and a sodium sulfate by-product. The reducing agent is composed of methanol and hydrogen peroxide. The method further includes cooling the produced chlorine dioxide (ClO₂) gas and absorbing the cooled chlorine dioxide (ClO₂) by 4-10° C. of chilled water to obtain a chlorine dioxide (ClO₂) aqueous solution. The by-product sodium sulfate is filtered, washed, and recycled.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a process for preparing high-purity chlorine dioxide (ClO₂) by using methanol and hydrogen peroxide as reducing agent, according to the present invention.

FIG. 2 is a block diagram illustrating a preparation system configured to prepare high-purity chlorine dioxide (ClO₂), according to an embodiment of the present invention.

### DETAILED DESCRIPTION OF THE EMBODIMENTS

Some embodiments generally pertain to a method for preparing high-purity chlorine dioxide (ClO₂) by using methanol and hydrogen peroxide as a reducing agent includes injecting concentrated sulfuric acid and sodium chlorate solution into a generator system to form a reaction mother liquid. The method also includes adding the reducing agent into the reaction mother liquid to produce chlorine dioxide (ClO₂) gas and by-product sodium sulfate. The method further includes cooling and absorbing the produced chlorine dioxide (ClO₂) gas by 4-10° C. chilled water to obtain a chlorine dioxide (ClO₂) aqueous solution. The by-product sodium sulfate is filtered, washed, and recycled.

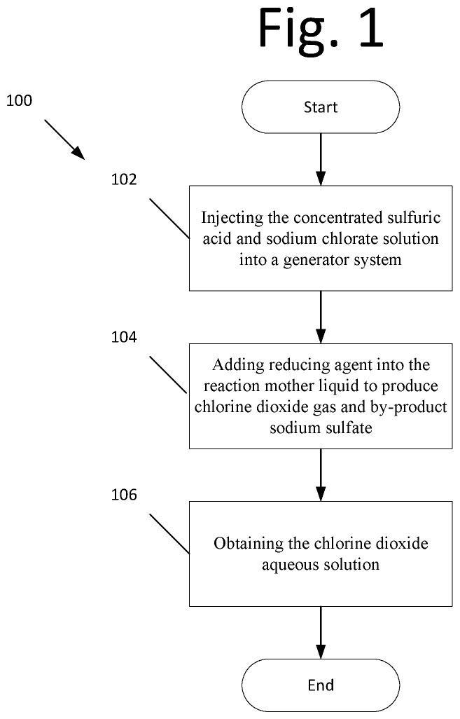

FIG. 1 is a flow diagram illustrating a process for preparing high-purity chlorine dioxide (ClO₂) by using methanol and hydrogen peroxide as reducing agent, according to the present invention.

Process 100 begins at 102 with injecting concentrated sulfuric acid and sodium chlorate solution into a generator to form a reaction mother liquid. In some embodiments, the reaction mother liquid is maintained at (1) an acidity level between 5.8-6.2N, (2) at a sodium chlorate content level between 234-266 g/l, and (3) at a temperature between 69-73° C. In certain embodiments, the generator is maintained in a vacuum and pressure set between −78 to −82 kPa.

At 104, the reducing agent is added into the reaction mother liquid to produce chlorine dioxide (ClO₂) gas and a by-product sodium sulfate. The reducing agent is composed of methanol and hydrogen peroxide, in some embodiments. The ratio of methanol to hydrogen peroxide by mass percentage is between 60-70 percent methanol and 30-40 percent hydrogen peroxide, for example.

In some embodiments, methanol may be diluted with demineralized water to a volume concentration of 20 percent and may then be added to the reaction mother liquid from a venturi pipe at the reboiler outlet.

In a further embodiment, the hydrogen peroxide may be prepared as a hydrogen peroxide solution with a mass concentration of 30 percent. The hydrogen peroxide solution may then be mixed with the sodium chlorate solution and may be added to the reaction mother liquid by way of an inlet of the reboiler. The ratio of methanol to hydrogen peroxide is 66 percent methanol and 34 percent hydrogen peroxide, in some embodiments.

At 106, the produced chlorine dioxide (ClO₂) gas is cooled and absorbed by 4-10° C. of chilled water to obtain a chlorine dioxide (ClO₂) aqueous solution. Also, in this embodiment, the by-product sodium sulfate is filtered, washed, and recycled.

In this embodiment, the chlorine dioxide (ClO₂) gas may be discharged from the top of the generator, and mixing the gas temperature of the chlorine dioxide (ClO₂) gas and the steam generated by the generator. The mixed gas temperature of the chlorine dioxide (ClO₂) gas and the steam generated by the generator is between 57-68° C., for example. The temperature of the chlorine dioxide (ClO₂) gas and the steam generated by the generator may be gradually cooled anywhere between 38-45° C. by the intercooler. The chlorine dioxide (ClO₂) gas and the steam generated by the generator may then enter the chlorine dioxide (ClO₂) absorption tower. Within the chlorine dioxide (ClO₂) absorption tower, the chlorine dioxide (ClO₂) aqueous solution is formed by chilled water spray and absorption, for example.

In another embodiment, concentrated sulfuric acid and sodium chlorate solution are injected into a generator to form a reaction mother liquid. In this embodiment, the reaction mother liquid is maintained at a predefined acidity level, temperature, and sodium chlorate content. The reaction mother liquid may react with a reducing agent to produce chlorine dioxide (ClO₂) gas and by-product sodium sulfate. The chlorine dioxide (ClO₂) gas is cooled and absorbed by low temperature chilled water to obtain an aqueous solution of chlorine dioxide (ClO₂). The by-products sodium sulfate are filtered, washed, and recycled.

Below is an example of a reaction principle for producing chlorine dioxide (ClO₂):

ClO₃⁻+Cl⁻+H⁺→ClO₂+Cl.+H₂O (1)

Cl.+Cl.→Cl₂ (2)

Cl.+CH₃OH→Cl⁻+H₂O+COOH⁻ (3)

H₂O₂+Cl₂→H⁺+Cl⁻+O₂ (4)

In certain embodiments, sodium chlorate may react (1) in an acid medium to generate chlorine dioxide (ClO₂) gas and chlorine radicals. Methanol may act as reducing agent and may react with chlorine radicals according to reaction (3). This reaction converts chlorine radicals into chloride ions, thereby reducing or avoiding the reaction (2) of chlorine radicals. Chlorine gas is generated so that chloride ions can be reused throughout the reaction process.

However, in actual production, since the reaction rate of reaction (3) is insufficient to completely convert all of the chlorine radicals into chloride ions, the purity of chlorine dioxide (ClO₂) prepared by using methanol as a reducing agent is not high. In some embodiments, hydrogen peroxide is used with methanol, as reducing agent, to prepare chlorine dioxide (ClO₂) through reaction (4). Also, in some embodiments, the chlorine gas is reduced to chloride ions by hydrogen peroxide, thus the generation of chlorine gas is greatly decreased, and the purity of chlorine dioxide (ClO₂) gas is improved.

In certain embodiments, a reducing agent composed of methanol and hydrogen peroxide is utilized. The reducing agent may react with sodium chlorate in a titanium container under strong acid, certain temperature and vacuum conditions to continuously produce high-purity chlorine dioxide (ClO₂) and by-product sodium sulfate. After cooling, chlorine dioxide (ClO₂) gas is absorbed by low-temperature chilled water to obtain the chlorine dioxide (ClO₂) solution with a certain concentration, and the by-product is filtered, washed and recycled.

The chlorine dioxide (ClO₂) solution produced by above-identified has a 60-70 percent reduction in the chlorine (Cl₂) content and 14-20 percent reduction in sulfuric acid consumption than that of the chlorine dioxide (ClO₂) produced by using a single methanol reducing agent. Further, with this process, the by-product produced is sodium sulfate, not sodium hydrogen sulfate, so neutralization reaction treatment is not required.

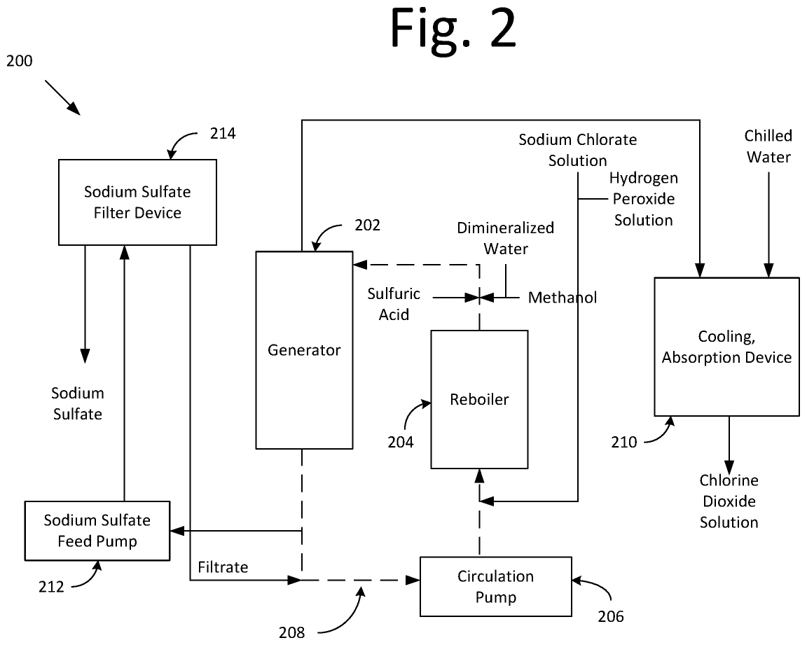

FIG. 2 is a block diagram illustrating a preparation system 200 configured to prepare high-purity chlorine dioxide (ClO₂), according to an embodiment of the present invention. In an embodiment, concentrated sulfuric acid enters generator 202 from one side of a venturi pipe, which is near an outlet of reboiler 204. Methanol is diluted by adding demineralized water, and the diluted methanol enters generator 202 from the other side of venturi pipe. Hydrogen peroxide is mixed with sodium chlorate solution prior to entering reboiler 204 from an outlet pipe of circulation pump 206. The hydrogen peroxide mixed with sodium chlorate solution enters generator 202 by way of reboiler 204.

In some embodiments, a circulation pipe 208 is configured to continuously circulate the reaction mother liquid between generator 202 and circulation pump 210. Circulation pump 210 is configured to facilitate the continuous circulation of the reaction method liquid in some embodiment.

Reboiler 204 is configured to heat the reaction mother liquid to a predetermined temperature and further configured to maintain the temperature required for the reaction. Both, generator 202 and reboiler 204 are connected through circulation pipe 212 to form a circulation circuit 208.

With the addition of methanol and hydrogen peroxide, generator 202 is configured to continuously generate chlorine dioxide (ClO₂). The chlorine dioxide (ClO₂) and the evaporated water vapor are discharged from the top of generator 202 and into an intercooler (see cooling, absorption 210). After the chlorine dioxide (ClO₂) and the evaporated water vapor are cooled by the intercooler, the chlorine dioxide (ClO₂) and the evaporated water vapor enters the chlorine dioxide (ClO₂) absorption tower. In some embodiments, the intercooler and the chlorine dioxide (ClO₂) absorption tower form cooling and absorption device 214. Cooling and absorption device 214 is filled with chilled water to absorb chlorine dioxide (ClO₂) to form the chlorine dioxide (ClO₂) aqueous solution.

The solid content within generator 202 is controlled to a certain concentration range. Sodium sulfate feed pump 212 is configured to pump the sodium sulfate produced within generator 202 together with the reaction mother liquid from the bottom of generator 202. Sodium sulfate feed pump 212 is further configured to send produced sodium sulfate and reaction mother liquid to sodium sulfate filter device 214 for filtration and recycle. Sodium sulfate filter device 214 is configured to filter out the sodium sulfate and is further configured to return the filtrate to circulation pump 206. This way, the filtered reaction mother liquid is returned to generator 202 by way of circulation pump 210 and reboiler 204.

In an embodiment, the entry point of methanol is at the venturi pipe, which is near the outlet of reboiler 204. The entry point of hydrogen peroxide, however, is between the inlet of reboiler 204 and the outlet of circulation pump 206.

### Example Embodiment 1

In one example, 186 kg of 98 percent mass concentrated sulfuric acid and 547 kg of 30 percent mass concentration sodium chlorate solution are injected into generator 202 to form a reaction mother liquid. The reaction mother liquid may circulate in the circulation pipe of generator 202 under the action of a circulation pump 206 and is maintained at an acidity level between 5.8-6.2 N and at a sodium chlorate content level between 234-266 g/l. Reboiler 204 may transfer heat to the reaction mother liquid to maintain temperature between 69-73° C. 20 percent (v/v) methanol with a weight of 44.8 kg and 30 percent (w/w) hydrogen peroxide with a weight of 16.3 kg are continuously and uniformly injected into generator 202 to produce chlorine dioxide (ClO₂). In this embodiment, generator 202 maintains vacuum, pressure at −78 to −82 kPa(g).

Under a negative pressure condition, the temperature of the mixed gas of chlorine dioxide (ClO₂) and water vapor discharged from generator 202 is between 57-68° C. and is preliminarily lowered to a temperature between 38-45° C. by an intercooler. In this example, gas enters the chlorine dioxide (ClO₂) absorption tower (cooling, absorption device 210) and is sprayed with 4-10° C. chilled water to produce a chlorine dioxide (ClO₂) solution. By-products are generated and continue to form precipitated crystals in the reaction mother liquid as the reaction progresses. To maintain the volume percentage of the solids in the reaction mother liquid between 18-23 percent, the reaction mother liquid containing sodium sulfate is pumped out from the bottom of generator 202. The by-product sodium sulfate is filtered out by sodium sulfate filter device, and the filtrate is returned to generator 202. The concentration of the chlorine dioxide (ClO₂) solution produced is 9.4 g/l, the chlorine (Cl₂) content of the solution is 0.08 g/l, and the sulfuric acid consumption is 0.86 t/tClO₂.

### Example Embodiment 2

186 kg of 98 percent mass concentration sulfuric acid and 547 kg of 30 percent mass concentration sodium chlorate solution are injected into generator 202 to form a reaction mother liquid. The reaction mother liquid in some embodiments circulates by circulation pipe 208 under the action of circulation pump 206. Also, in some embodiments, the reaction mother liquid is maintained at an acidity level between 5.8-6.2 N and with a sodium chlorate content level between 234-266 g/l. Heat is then transferred to the reaction mother liquid by reboiler 204 to maintain a temperature of 69-73° C. 20 percent (v/v) methanol with a weight of 46.5 kg and 30 percent (w/w) hydrogen peroxide with a weight of 14.3 kg are continuously and uniformly injected into generator 202 to produce chlorine dioxide (ClO₂). Generator 202 is configured to maintain vacuum, with pressure between −78 to −82 kPa(g).

Under a negative pressure condition, the temperature of the mixed gas of chlorine dioxide (ClO₂) and water vapor discharged from generator 202 is between 57-68° C. and is preliminarily lowered to a temperature between 38-45° C. by an intercooler. Gas enters the chlorine dioxide (ClO₂) absorption tower and is sprayed with 4-10° C. chilled water to produce chlorine dioxide (ClO₂) solution. By-products are generated and continue to form precipitated crystals in the reaction mother liquid as the reaction progresses. To maintain the volume percentage of the solids in the reaction mother liquid between 18-23 percent, the reaction mother liquid containing sodium sulfate is pumped out from the bottom of generator 202, and by-product sodium sulfate is filtered out by sodium sulfate filter device 214. The filtrate is then returned back to generator 202. The concentration of the chlorine dioxide (ClO₂) solution produced is 9.5 g/l, the chlorine (Cl₂) content of the solution is 0.09 g/l, and the sulfuric acid consumption is 0.87 t/tClO₂.

### Example Embodiment 3

186 kg of 98 percent mass concentration sulfuric acid and 547 kg of 30 percent mass concentration sodium chlorate solution are injected into generator 202 to form a reaction mother liquid. In some embodiments, the reaction mother liquid circulates in circulation pipe 208 under the action of circulation pump 206. Also, in some embodiments, the reaction mother liquid is maintained at an acidity level between 5.8-6.2 N and a sodium chlorate content between 234-266 g/l.

Heat is transferred to the reaction mother liquid by reboiler 204 to maintain a temperature between 69-73° C. 20 percent (v/v) methanol with a weight of 45 kg and 30 percent (w/w) hydrogen peroxide with a weight of 12.6 kg are separately, continuously and uniformly injected into generator 202 to produce chlorine dioxide (ClO₂). In some embodiments, generator 202 maintains vacuum, pressure between −78 to −82 kPa(g).

Under a negative pressure condition, the temperature of the mixed gas of chlorine dioxide (ClO₂) and water vapor discharged from generator 202 is between 57-68° C. and is preliminarily lowered to a temperature between 38-45° C. by the intercooler. Gas enter the chlorine dioxide (ClO₂) absorption tower and is sprayed with 4-10° C. chilled water to produce chlorine dioxide (ClO₂) solution. By-products are generated and continue to form precipitated crystals in the reaction mother liquor as the reaction progresses.

To maintain the volume percentage of the solids in the reaction mother liquid between 18-23 percent, the reaction mother liquid containing sodium sulfate is pumped out from the bottom of generator 202. The by-product sodium sulfate is then filtered out by sodium sulfate filter device 214, and the filtrate is returned to generator 202 by way of circulation pump 206 and reboiler 204. The concentration of the chlorine dioxide (ClO₂) solution produced is 9.3 g/l, the chlorine (Cl₂) content of the solution is 0.07 g/l, and the sulfuric acid consumption is 0.87 t/tClO₂.

Some embodiments generally pertain to a method for producing high-purity chlorine dioxide (ClO₂) by using a methanol and hydrogen peroxide as a reducing agent includes injecting concentrated sulfuric acid and sodium chlorate solution into a generator to form a reaction mother liquid. The generator being maintained in a vacuum and pressure being set between −78 to −82 kPa. The method also includes adding the reducing agent into the reaction mother liquid to produce chlorine dioxide (ClO₂) gas and a sodium sulfate by-product. The reducing agent is composed of methanol and hydrogen peroxide. The method further includes cooling the produced chlorine dioxide (ClO₂) gas and absorbing the cooled chlorine dioxide (ClO₂) by 4-10° C. of chilled water to obtain a chlorine dioxide (ClO₂) aqueous solution. The by-product sodium sulfate is filtered, washed, and recycled.

It will be readily understood that the components of various embodiments of the present invention, as generally described and illustrated in the figures herein, may be arranged and designed in a wide variety of different configurations. Thus, the detailed description of the embodiments, as represented in the attached figures, is not intended to limit the scope of the invention as claimed but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method for preparing high-purity chlorine dioxide (ClO₂) by using methanol and hydrogen peroxide as a reducing agent, the method comprising:
injecting concentrated sulfuric acid and sodium chlorate solution into a generator system to form a reaction mother liquid, wherein the reaction mother liquid is maintained at an acidity of 5.8-6.2 N, sodium chlorate content is between 234-266 g/l, and temperature is maintained at 69-73° C., the generator system comprising a reactor and a reboiler connected by a circulation pipe;
adding the reducing agent into the reaction mother liquid to produce chlorine dioxide (ClO₂) gas and by-product sodium sulfate, wherein the reducing agent is composed of methanol and hydrogen peroxide and the ratio of methanol to hydrogen peroxide by mass percentage is between 60-70 percent of methanol and 30-40 percent of hydrogen peroxide; and
cooling and absorbing the produced chlorine dioxide (ClO₂) gas by 4-10° C. chilled water to obtain a chlorine dioxide (ClO₂) aqueous solution, wherein the by-product sodium sulfate is filtered, washed, and recycled.

2. The method of claim 1, further comprising:
prior to adding the reducing agent, diluting the methanol with demineralized water to a volume concentration of 20 percent, and
adding the diluted methanol to the reaction mother liquid from a venturi pipe at the reboiler outlet.

3. The method of claim 2, further comprising:
prior to adding the reducing agent, preparing the hydrogen peroxide as a hydrogen peroxide solution with a mass concentration of 30 percent;
mixing the prepared hydrogen peroxide with the sodium chlorate solution; and
adding the mixed hydrogen peroxide to the reaction mother liquid from an inlet of the reboiler.

4. The method of claim 2, further comprising:
maintaining vacuum and pressure within the generator between −78 to −82 kPa.

5. The method of claim 2, further comprising:
discharging the chlorine dioxide (ClO₂) gas from top of the generator;
mixing gas temperature of the chlorine dioxide (ClO₂) gas and steam generated by the generator, wherein the mixed gas temperature of the chlorine dioxide (ClO₂) gas and steam generated by the generator is between 57-68° C.;
gradually cooling the mixed gas temperature of the chlorine dioxide (ClO₂) gas and steam generated by the generator to 38-45° C. by an intercooler; and
entering the cooled gas temperature of the chlorine dioxide (ClO₂) gas and steam generated by the generator into the chlorine dioxide (ClO₂) absorption tower, such that a chlorine dioxide (ClO₂) aqueous solution is formed by spraying and absorbing chilled water.

6. The method of claim 2, wherein preferred ratio of the methanol to hydrogen peroxide is 66 percent of methanol and 34 percent of hydrogen peroxide.

7. A method for producing high-purity chlorine dioxide (ClO₂) by using a methanol and hydrogen peroxide as a reducing agent, the method comprising:
injecting concentrated sulfuric acid and sodium chlorate solution into a generator to form a reaction mother liquid, wherein the generator is maintained in a vacuum and pressure set is between −78 to −82 kPa;
adding the reducing agent into the reaction mother liquid to produce chlorine dioxide (ClO₂) gas and a sodium sulfate by-product, wherein the reducing agent is composed of methanol and hydrogen peroxide; and
cooling the produced chlorine dioxide (ClO₂) gas and absorbing the cooled chlorine dioxide (ClO₂) by 4-10° C. of chilled water to obtain a chlorine dioxide (ClO₂) aqueous solution, wherein
the by-product sodium sulfate is filtered, washed, and recycled.

8. The method of claim 7, wherein the reaction mother liquid is maintained at an acidity level between 5.8-6.2N, at a sodium chlorate content level between 234-266 g/l, and at a temperature between 69-73° C.

9. The method of claim 7, wherein a ratio of methanol to hydrogen peroxide by mass percentage is between 60-70 percent methanol and 30-40 percent hydrogen peroxide.

10. The method of claim 7, further comprising:
diluting methanol with demineralized water to a volume concentration of 20 percent; and
adding diluted methanol to the reaction mother liquid by way of a venturi pipe at an outlet of a reboiler.

11. The method of claim 7, further comprising:
preparing the hydrogen peroxide as a hydrogen peroxide solution with a mass concentration of 30 percent;
mixing the hydrogen peroxide solution with the sodium chlorate solution; and
adding the mixed hydrogen peroxide to the reaction mother liquid by way of an inlet of the reboiler, wherein
the ratio of methanol to hydrogen peroxide is 66 percent methanol and 34 percent hydrogen peroxide.

12. The method of claim 7, further comprising:
discharging the chlorine dioxide (ClO₂) gas from top of the generator;
mixing gas temperature of the chlorine dioxide (ClO₂) gas and steam generated by the generator;
gradually cooling the mixed gas temperature of the chlorine dioxide (ClO₂) gas and steam generated by the generator to 38-45° C. by an intercooler; and
transporting the cooled gas temperature of the chlorine dioxide (ClO₂) gas and steam generated by the generator into the chlorine dioxide (ClO₂) absorption tower, such that a chlorine dioxide (ClO₂) aqueous solution is formed by spraying and absorbing chilled water.

13. The method of claim 12, wherein the mixed gas temperature of the chlorine dioxide (ClO₂) gas and steam generated by the generator is between 57-68° C.
